(19) United States
(12) Patent Application Publication
(10) Pub. No.: US 2025/0028514 A1
(43) Pub. Date: Jan. 23, 2025

(54) AUTOMATIC SELF-ADAPTING APPLICATION DEPLOYMENT FOR CLOUD APPLICATIONS

(71) Applicant: StackGen. Inc., San Ramon, CA (US)

(72) Inventors: Asif Awan, Dublin, CA (US); Sachin Aggarwal, San Ramon, CA (US); Cesar A. Rodriguez Encarnacion, Reisterstown, MD (US); Taylor Joseph Becker, Billerica, MA (US)

(21) Appl. No.: 18/777,973

(22) Filed: Jul. 19, 2024

Related U.S. Application Data
(60) Provisional application No. 63/514,667, filed on Jul. 20, 2023.

(51) Int. Cl. G06F 8/61

(52) U.S. Cl. CPC G06F 8/61

(57) ABSTRACT

Embodiments of the present disclosure include techniques for automated deployment of applications to cloud environments. In one embodiment, application source code and configuration files are analyzed for dependencies on one or more cloud computing environments. A model is created, and the model searched for cloud resource calls. A dependency file is generated. In some embodiments, policies are stored in a policy database. Cloud resource templates are customized to configure cloud resources to conform to the policies. Infrastructure-as-code (IaC) files are generated. Cloud environments and the cloud resources may be provisioned automatically using the IaC files to deploy the application.

### CROSS REFERENCE TO RELATED APPLICATIONS

This application claims priority to U.S. Patent Provisional Application Ser. No. 63/514,667, filed on Jul. 20, 2023, the disclosure of which is hereby incorporated herein by reference.

### BACKGROUND

The present disclosure relates generally to software systems, and in particular, to systems and methods for automated application deployment of application software to cloud environments.

Cloud computing has revolutionized the deployment and management of applications, offering scalability, flexibility, reliability, and cost savings. However, the proliferation of cloud providers, services, resources, and tools has led to fragmented application deployments, posing challenges for organizations in maintaining consistency, efficiency, and security.

Existing solutions, such as AWS CDK and certain other custom solutions (aka, blackbox solutions), have limitations. Blackbox solutions mainly target serverless applications and provide limited support for other application types. These approaches typically require users to learn and interact with a customized interface, which locks the user into a customized approach, and also typically lack customization options. Template-based solutions lack flexibility and typically have a high overhead.

The present disclosure addresses these and other challenges and is directed to techniques for automated cloud deployment of applications.

### BRIEF DESCRIPTION OF THE DRAWINGS

FIG. 1 illustrates a system for automated application deployment of cloud applications according to an embodiment.

FIG. 2 illustrates a method according to an embodiment.

FIG. 3 illustrates an example automated application deployment system according to another embodiment.

FIG. 4 illustrates another example method according to an embodiment.

FIG. 5 illustrates an example application source code analysis method according to an embodiment.

FIG. 6 illustrates an example dependency specification according to an embodiment.

FIG. 7 illustrates integration of policy data into autogenerated IaC files according to an embodiment.

FIG. 8 illustrates a method of integrating policy data into autogenerated IaC files according to another embodiment.

FIG. 9 illustrates a hardware architecture of a computing system configured according to the above disclosure.

### DETAILED DESCRIPTION

Described herein are techniques for automated application deployment of cloud applications. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein.

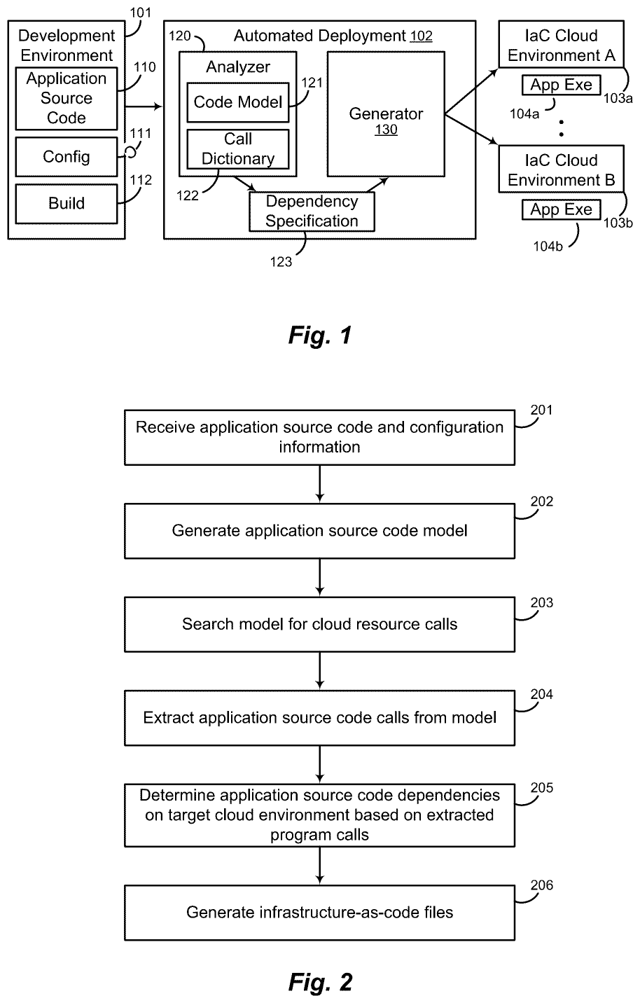

FIG. 1 illustrates a system for automated application deployment of cloud applications according to an embodiment. Software applications are software programs executed by computer systems, such as a local computer or a cloud computing environment, to perform a wide variety of functions. Typically, a software developer writes application source code 110 in a development environment 101 to implement the desired functionality. Example programming languages include Java, .NET, C#, Python, Go, or JavaScript, for example. Application source code 110 often includes one or more configuration files 111 to allow users to configure the application in a variety of ways, which may include defining how the application accesses and uses cloud resources, for example. Configuration information may define the parameters, options, settings, and preferences for using the application. Configuration files 111 is typically accessed by an application at runtime (e.g., a compiled and executed application). Configuration files 111 may also be used to retrieve or send an application's dependencies on cloud resources, how different parts or components or modules of an application communicate with each other, how any keys or secrets need to be fetched in order to provide the application access to protected storage resources that the applications uses, and/or a number of other uses, for example.

Additionally, application source code 110 may be associated with a build file 112. Build files provide information for converting the source code to executable code. Executable code for the application may be run on a test environment and/or production environment deployed in a cloud computing environment, for example. Build files further indicate how the application code is to be bundled for deployment and execution (e.g., a container image). Build files typically indicate to compilers or interpreters (depending on the source code language) what libraries/frameworks, which that application depends on, to include as well as what version to include. A build file may also specify what build options, such as what optimizations, are to be performed and whether to add memory/limit checks, etc.

After the application source code and related files are created, it is often desirable to deploy the application in executable form onto one or more different types of cloud computing environment (e.g., production or test). A cloud computing environment is a virtual infrastructure that allows users to access, manage, and store data and applications over the internet, instead of relying on local hardware or servers. A cloud computing environment (aka, cloud environment) typically includes cloud infrastructure (e.g., a set of hosted servers, storage, networks, etc.) and cloud resources (e.g., applications and/or other digital services) typically available over a network, such as the Internet. Example cloud environments include, but are not limited to, Amazon Web Services (AWS), Microsoft Azure, and Google Cloud Platform (GCP). Cloud environments typically include a wide range of digital resources including, but not limited to, virtual machines, storage accounts, web apps, databases, messaging systems, AWS Simple Storage Service (S3), Azure Active Directory, Google Kubernetes Engine (GKE), serverless applications (e.g., Lambda Function, API Gateway, or DynamoDB), and virtual networks to name just a few of many examples. For example, components of a cloud computing environment may include Infrastructure as a Service (virtualized computing resources over the Internet, such as Amazon Elastic Cloud Compute, EC2), Platform as a Service (hardware and software tools for application development), Software as a Service (software applications available over the Internet), and storage (flexible and scalable cloud storage services, such as Amazon Simple Storage Service, S3).

Infrastructure as code (IaC) is a type of software code that provisions and supports computing cloud infrastructure and cloud resources using code instead of manual processes and settings. Application environments typically require many cloud infrastructure components such as operating systems, database connections, and storage. Developers previously needed to set up, update, and maintain the cloud environment infrastructure to develop, test, and deploy applications. Much like software code describes an application and how it works, infrastructure as code (IaC) describes a cloud system architecture and how it works. A cloud computing environment contains infrastructure such as servers, networking, operating systems, and storage, as well as various digital resources accessible via cloud resource calls. IaC controls virtualized infrastructure and resources by treating cloud environment configuration files like source code files, which can be used to manage a cloud deployment in a codified, repeatable way. IaC configuration management tools may use different language specifications. IaC may be developed similar to application code in Python or Java, for example. IaC may also be written in an integrated development environment (IDE) with built-in error checking and may be maintained under source control with commits at each code change. Accordingly, IaC files may be included as part of the wider codebase and used for a variety of purposes including, but not limited to, setting up complete cloud environments, from development to production, ensuring consistently reproducible configurations between environments, and seamlessly integrating with cloud providers and efficiently scaling cloud environment infrastructure up or down based on demand, for example.

Typically, deploying application source code 110 required a time intensive, manual process of writing the IaC code for provisioning the cloud resources that the application needs for its successful execution. However, IaC coders often know little about the structure and operation of application source code 110 and the application's exact dependencies on the cloud resources. Conversely, application developers often know little about how to write IaC code to deploy their applications in a cloud environment. Accordingly, features and advantages of the present disclosure include an automated application deployment system 102 that receives application source code 110 and generates IaC files 103a and/or 103b automatically to deploy an executable version of the application code 104a and/or 104b in one or more cloud environments, for example.

As illustrated in FIG. 1, an automated deployment software system 102 executing on at least one computer system (not shown) includes an analyzer 120 and generator 130. Analyzer 120 may receive application source code 110 and configuration information 111. As mentioned above, configuration information 111 may include configuration information specifying (at least in part) which cloud resources the application source code 110 relies on and configurations for the cloud resources. In some embodiments, an analyzer 120 may generate a model 121 based at least in part on the application source code 110. Model 121 defines dependencies between the application source code 110 and cloud resources on certain cloud environments to which the application source code may be deployed. In some embodiments, a model 121 may represent at least a structure, a control flow, and a data flow of the application source code 110, for example, and cloud resources of the cloud environments. In one example embodiment, model 121 may be a code property graph (CPG). In another embodiment, model 121 may be an abstract syntax tree (AST).

Automated deployment system 102 may include a call dictionary 122. Call dictionary 122 comprises predefined cloud resource calls for the cloud environments that the application source code 110 is to be deployed on (aka, target cloud environments). Cloud resource calls comprise calls to cloud software resources (e.g., services) that applications rely on (use), such as AWS S3 Bucket, AWS RDS, AWS SQL, and the like. Cloud resource calls are typically defined and provided by cloud system providers (e.g., AWS, Azure, Google Cloud). Cloud resource calls may be included in application source code line(s) that invoke cloud resource services (e.g., boto3.resource(‘s3’) for AWS S3 in Python, AWS.S3( ) in Node.js). Accordingly, analyzer 120 may determine an application's dependency on cloud resources by analyzing the static source code (e.g., without analyzing the code at runtime), for example, advantageously without requiring any annotations, custom SDK calls, or other modifications to the application source code itself. Static source code analysis is typically referred to as static code analysis. Analyzer 120 may use model 121 and call dictionary 122 to find and extract calls in application source code 110. Analyzer 120 may thus determine which cloud resource calls the application is dependent upon, for example. As described in more detail below, analyzer 120 may search for “hits” of a particular cloud resource call in application source code model 121. If a hit is discovered, dependencies between the application source code and particular resources in the cloud environment may be determined.

In some embodiments described in more detail below, analyzer 120 may determine parameters associated with application source code calls to cloud resources using model 121. For example, analyzer 120 may trace through the model 121 embodying applications source code 110 to extract parameter values for each determined parameter, for example. Accordingly, the system captures different cloud resource dependencies for different applications. As but one example, parameter values for an S3 bucket call in one application may include “read only” privileges to an S3 bucket, while parameter values for an S3 bucket instance in another application may include “read” and “write” (aka, read/write) privileges. Thus, some embodiments of the present disclosure may advantageously capture granular privilege details, which may be useful in embodiments applying policies as described below, such as fine grained least privilege, for example.

Call dictionary 122 may be implemented in a variety of ways. In some embodiments, call dictionary 122 comprises a data store of calls available from multiple cloud providers. In one embodiment described in more detail below, call dictionary 122 may comprise code for receiving at least a portion of model 121 as an input and outputting predefined cloud resource calls found in the model, for example. Accordingly, in various embodiments, cloud resource call names may be stored in the analyzer code base, files, or a data store (e.g., the latter two may be retrieved by the analyzer code base). In some embodiments, an indication of the target cloud environment(s) may be used to search for particular cloud resource calls. In some embodiments, an indication of the target cloud environment(s) may be provided by a user. In other embodiments, target cloud environments may be determined automatically from an analysis of the inputs (e.g., “indicators” determined from the source code, configuration files, dependency libraries, etc. . . . ). Accordingly, some embodiments may search model 121 using call dictionary 122 for cloud resource calls for particular cloud environments.

Based on the above, analyzer 120 determines application source code dependencies on a cloud resources based, at least in part, on application source code calls in model 121 (e.g., and/or based on the configuration files 111). Analyzer 120 may generate a dependency specification 123 mapping particular application source code calls (and parameter values) in application source code 110 to cloud resources in one or more target cloud environments. An example dependency specification is provided below.

Automated deployment system 102 includes a generator 130. Generator 130 may receive the dependency specification 123 and generate infrastructure-as-code (IaC) files based on the determined application source code dependencies to deploy executable application code corresponding to the application source code on one or more target cloud environments. As illustrated in FIG. 1, automated deployment system 102 may generate IaC files for provisioning one or multiple cloud environments. In some embodiments, application source code 110 may be input to automated application deployment system 102 to automatically generate IaC files 103a for cloud environment A (e.g., a particular version of AWS) to deploy an executable version of the application 104a. In other embodiments, application source code 110 may be input to automated application deployment system 102 to automatically generate IaC files 103b for cloud environment B (e.g., a particular version of Azure or Google Cloud) to deploy executable version of the application 104b. In yet other embodiments, some components of application source code 110 may be used to generate IaC files for cloud environment A while other components of application source code 110 may be used to generate IaC files for cloud environment B, for example. In various embodiments, new cloud environments may be generated or existing cloud environments modified to deploy an executable version of an application. For example, using the IaC files to provision a cloud environment may include generating at least one new target cloud environment, for example. Similarly, using IaC files to provision a cloud environment may include modifying an existing cloud environment to deploy an application, for example.

FIG. 2 illustrates a method according to an embodiment. At 201, application source code and configuration information is received. The configuration information may include configuration information specifying particular cloud resources the application source code relies on and configurations for the particular cloud resources. As mentioned above, build files and other code constructs may also be received in some embodiments. At 202, a model of the source code is generated from the application source code. The source code model may embody dependencies between the application source code and resources on the plurality of cloud environments. In some embodiments, the model is a code property graph. At 203, the model is searched for cloud resource calls. For example, a call dictionary may store cloud environment calls for a plurality of cloud environments, which may be compared to calls embodied in the model. At 204, calls in the application source code are extracted from the model. At 205, application source code dependencies on a target cloud environment are determined based, at least in part, on the calls used in the application source code and embodied in the model. In some embodiments, the model is used to determine call parameters, and the model may be traced (e.g., across nodes and edges) to determine call parameter values. At 206, infrastructure-as-code (IaC) files are generated based, at least in part, on the determined application source code dependencies to deploy executable application code corresponding to the application source code on the target cloud environment.

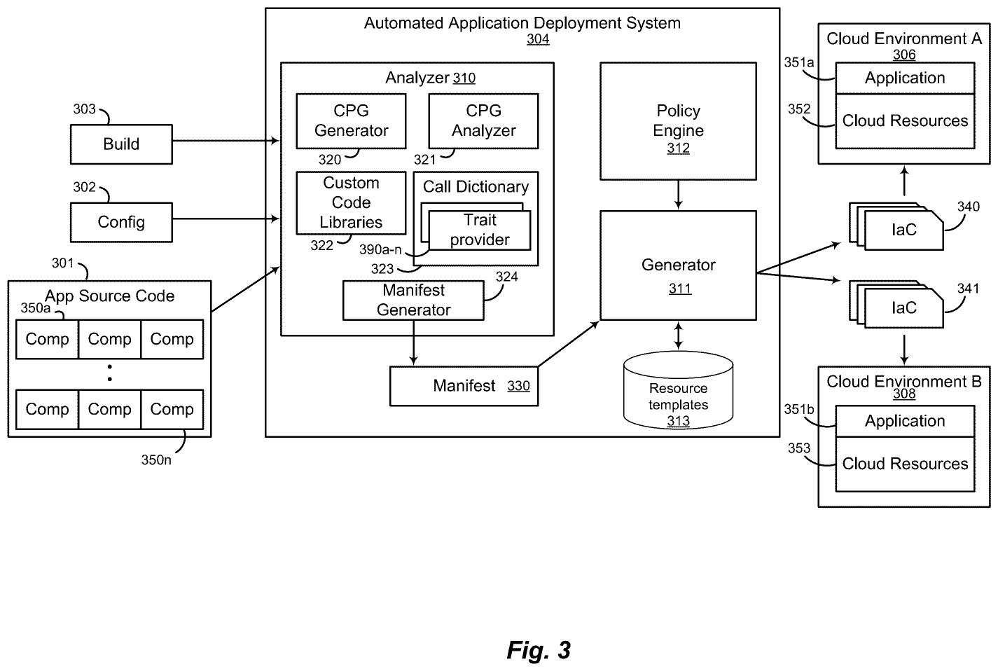

FIG. 3 illustrates an example automated application deployment system 304 according to another embodiment. In this example, application software source code 301 comprises a plurality of components 350a-n. Components 350a-n may be source code components comprising procedures, functions, methods, and other functional units such as programming language frameworks (e.g., Java SpringBoot), which may be grouped together to perform particular functions, related functions, microservices, or the like. In some situations, it may be advantageous to deploy different components 350a-n on different target cloud environments, for example. Accordingly, features and advantages of the present disclosure include an automated application deployment system 304 that allows users to deploy a portion of components 350a-n of the application source code 301 on one target cloud environment (e.g., cloud environment 306) and one or more other portions of components 350a-n of the application source code 301 on one or more other target cloud environments (e.g., cloud environment 308). As mentioned above, in some embodiments, configuration information 302 and build information 303 may include information for deploying applications on target cloud environments supported by automated application deployment system 304, for example.

In this example, analyzer 310 comprises a code properties graph (CPG) generator 320, CPG analyzer 321, custom code library retrieval and integration component 322, call dictionary 323, and manifest generator 324. As mentioned above, features and advantages of some embodiments convert application source code 301 into a model embodying the structure, control flow, and data flow of the code. While a CPG is used as the model to illustrate certain features of the present example, it is to be understood that other models may be used in other embodiments. In this example, call dictionary 323 comprises trait providers 390a-n, which are described in more detail below. Manifest generator 324 generates a manifest 330 (aka, a dependency specification described above), an example of which is provided below. Manifest 330 is received in a generator 311. In some embodiments, generator 311 further receives policy information from a policy engine 312 and resource templates 313. As described in more detail below, resource templates may correspond to cloud resources that the application depends on, user inputs about how the cloud resources need to be configured, and/or cloud resources that the user wants to include in a deployment of the application, for example. A portion of an example resource template is illustrated below. Generator 311 outputs IaC files for one or more target cloud environments. In this example, generator 311 outputs IaC files 340. When executed, IaC files 340 provision cloud environment A 306, configure the cloud resources 352 for use by a first portion of components 350a-n of the application, and deploy an executable application 351a. Further, generator 311 outputs IaC files 341. When executed, IaC files 341 provision cloud environment B 308, configure the cloud resources 353 for use by another portion of components 350a-n of the application, and deploy an executable application 351b.

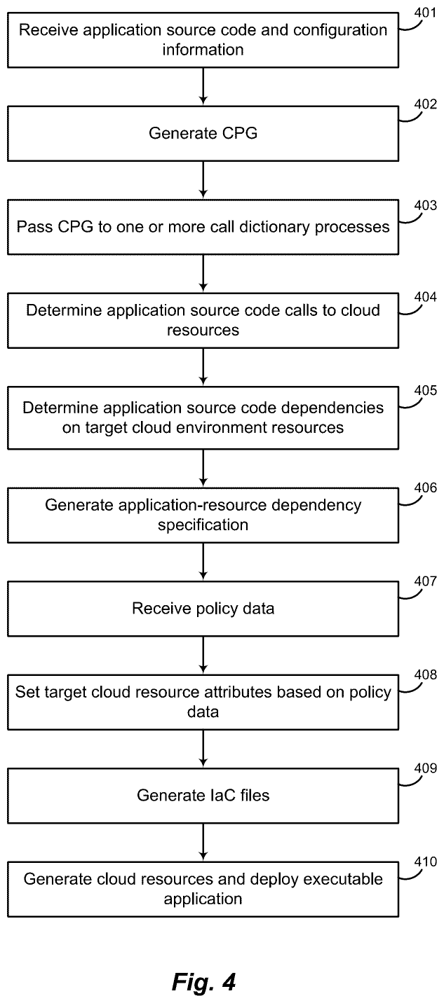

FIG. 4 illustrates an example process executed by analyzer 310 according to an embodiment. At 401, application source code and configuration information are received on one or more computer systems executing an automated application deployment system. At 402, a code property graph is generated from the application source code. At 403, the CPG may be passed to ore or more call dictionary processes. In this example, the call dictionary is a routine that takes the CPG and searches the CPG for particular cloud resource calls. For example, the CPG (or a pointer to the CPG) may be passed to a first process (e.g., a trait provider) to search for S3 bucket calls for AWS. Additionally, the CPG may be passed to a second process to search for another category of calls, and the CPG may be passed to other processes (e.g., other trait providers) configured to search the CPG for other categories of calls. In some embodiments, these processes and searches of the model may be performed in parallel to increase the operational speed of the system, for example. Accordingly, the model (here, the CPG) may be accessed by a plurality of processes each configured to search the model for different categories of cloud resource calls, for example, and for each category of the cloud environment calls, determine unique application source code dependencies on corresponding cloud resources. At 404, application source code calls to cloud resources are determined based on the search results (aka, hits) of each process. For example, the CPG may be queried for the cloud resource calls by multiple processes in parallel, each of which may store categories of cloud resource calls in memory (e.g., RAM) and traverse the CPG to determine if there is a match. As mentioned above, parameters of calls and parameter values of calls may also be extracted from the model. At 405, the system determines dependencies between the application source code and the target cloud resources based on the application source code calls to cloud resources found in the model. At 406, a manifest is generated specifying the application-cloud resource dependencies. In some embodiments, the manifest may include other dependencies (e.g., on other microservices or on user defined dependencies added to update the dependencies). The manifest may further include parameters used in cloud resource calls by the application source code as well as parameter values for such calls, for example. The manifest may, in turn, be used by the generator to produce IaC files.

FIG. 4 further illustrates another aspect of some embodiments of the present disclosure. In some embodiments, policy data is received by the generator at 407 and used to generate IaC files including policies (e.g., security policies) so the generated cloud environment implements the desired policies. Attributes of target cloud resources (e.g., a database access or application functionality access privileges) may be set (e.g., by a user or enterprise or automatically updated by a third party provider) based on the policy data at 408. Further examples and details regarding the incorporation of policy data into the automated deployment system are provided below.

At 409, infrastructure-as-code files may be generated based on the determined application source code dependencies (and in some cases, policy data) to deploy executable application code corresponding to the application source code on one or more target cloud environments. At 410, the IaC files may be executed to provision cloud resources and deploy the executable application (on one or more target cloud environments).

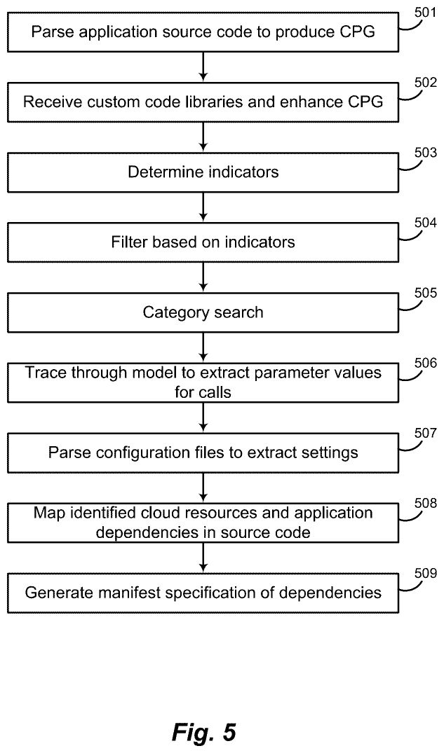

The operation of analyzer 310 is further described in FIG. 5. At 501, application source code is parsed by CPG generator 320 to produce the CPG. In some embodiments, application source code 301 may use custom code libraries 322 (e.g., with custom calls). Accordingly, at 502, custom code libraries 322 if FIG. 3 are received and used to enhance the CPG. For example, the system may receive one or more custom code libraries external to the application source code. The system may then expand the code properties graph to incorporate the custom code libraries. As a further example, some embodiments may generate a CPG using a tool (e.g., Joern), which may produce a basic CPG that lacks information needed to achieve certain dependencies. Embodiments of the disclosure may include performing additional analysis of the application source code to calculate more information and/or add new edges or nodes to the model's graph. For example, the following enhancements may be added to the model: control flow, type relationships, call graphs, language frontend-specific information such as JavaSrc2Cpg's type recovery pass (e.g., an additional pass against nodes trying to recover type information based on the call graph and type relationship information that wasn't found in the initial creation), and in some instances an open-source dataflow pass (calculating the data dependency graph). In one embodiment, tags may be added to nodes for easier querying or default language type information may be replaced (e.g., python frontend type boto3.client (“s3”) may be replaced with type ‘“boto3.py: <module>.client”’ because framework/library semantics may not be included in the Joern tool while it is known by the system that the type is boto3's S3.Client).

At 503, the system may determine certain indicators (e.g., traits in the model). For example, the analyzer may identify the language(s) the source code is written in (e.g., Java, Python, etc.). Additionally, as mentioned above, the analyzer may comprise a plurality of trait providers 390a-n (aka, trait indicators), which may comprise analyzer functions that accept the model (e.g., a link to the CPG) and produce traits for groupings, categories, or types of cloud resource calls). For example, particular trait providers may search the model for particular cloud resource calls and determine whether or not any of the calls for a particular trait provider exist in the model (e.g., each process returns hits for predefined cloud resource calls). These functions may further produce information about when the trait provider is relevant (e.g., so they can be skipped if not). For example, an AWS SDK for Java V2 S3 trait provider may be called to find S3 dependency traits for models created with Java source code, compiled Java (class files), or Kotlin source code when the S3 indicator is found.

As another example, the analyzer may include trait indicator functions used as an initial fast hint/indication that there exist some calls of interest for the given indicator both for potential usage in the application manifest and to limit a more processing expensive analysis needed to extract detailed dependency information. For example, the analyzer may include an AWS SDK for Java indicator function that searches the model for any calls with AWS SDK client-relevant methodFullNames (which would contain the full package name+function name), then maps those packages to the appropriate AWS service trait provider, for example.

At 504, indicators (e.g., coding language or target cloud resource information) may be used to filter searches for call types (or categories) on the model. In one example, trait provider functions returning categories of calls are first filtered by language, then any indicator providers or non-indicator-dependent providers are called, then the rest are called based on indicator presence/consumption.

In some embodiments, the analyzer may initially determine categories of cloud environment calls to cloud resources, and for each category of cloud environment calls, determine unique application source code dependencies on corresponding cloud resources. For example, the trait providers in the analyzer may categorize/group calls around different cloud environment resources such as AWS Java SDK S3, Spring Controller, DriverManager JDBC, or a wide variety of others. In some embodiments, the system may independently determine environment calls for each category, query a model (e.g. CPG) for matching calls (aka, “hits”), and determine dependencies, which allows the system to operate faster and more efficiently, for example. These category searches, which may be performed by one or more trait providers, are illustrated at 505. Advantageously, the system may determine parameters associated with each of the plurality of program calls from the code property graph. The system may then extract parameter values for each determined parameter from the code property graph. For instance, when a hit occurs, indicating a particular cloud resource is invoked in the application source code, the analyzer may trace through the CPG (or other model) to extract parameter values for the calls at 506.

As yet another detailed example of the above, the system may first identify cloud platform resource calls. The analyzer may identify specific APIs by identifying calls to specific cloud APIs (e.g., boto3.resource(‘s3’) for AWS S3 in Python or AWS.S3( ) in Node.js). CPG queries may be used to locate these calls within the application source code. An example query is: Query: cpg.call(“boto3.resource”) for identifying AWS S3 resource calls in Python. Next, relevant parameters may be extracted from these API calls that define resources (e.g., bucket names, database names). For example, “query: cpg.call(“boto3.resource”).argument(“s3”)” may get the parameter values. Next, the system may track parameter values to their definitions by performing a control and data flow analysis using the CPG to track the flow of parameters, and identify how parameter values are assigned, modified, and passed through the code. For example, a bucket name parameter may be tracked from an S3 resource call back to its assignment or source. In some instances, the system may identify if parameter values are sourced from environment variables, configuration files, or external libraries, and then use the CPG to track the flow of these values from their point of origin to their usage in API calls. For example, the query “cpg.identifier(“BUCKET_NAME”).assignedValue” may analyze the model to track the value of an environment variable used as a parameter.

Additionally, in some cases, the system may perform cross file and cross library tracking. Inter-Procedural Analysis may extend an analysis across different files and modules to track parameter values defined in one file and used in another and use the CPG's capability to link and query across files and libraries. For example, the system may identify a parameter defined in a configuration file and used in a cloud API call in another module, for example. Additionally, the system may perform library and framework specific handling to address specific cases where parameters are passed through a framework-specific mechanisms (e.g., dependency injection in Spring, middleware in Express.js). Customized CPG queries may be included in the system to account for these mechanisms.

Referring again to FIG. 5, the system may parse configuration files to extract settings at 507. In various example embodiments, the system may parse files such as YAML, JSON, XML, and properties files to extract relevant settings. For instance, SpringBoot applications often use application.properties or application.yml files for configuration. The following is an example configuration for Postgres:
spring.datasource.url=jdbc:postgresql://localhost:5432/mydb
spring.datasource.username=myuser spring.datasource.password=mypassword
spring.datasource.driver-class-name=org.postgresql.Driver

Some embodiments may use libraries like PyYAML for YAML files, json module for JSON files, and custom parsers for other formats, for example.

Various embodiments may identify patterns that indicate resource dependencies, such as keywords that are commonly associated with resource dependencies (e.g., terms like datasource, redis, database, host, port, username, password, etc.). As another example, Spring Boot uses specific prefixes for different types of resource configurations. Some common prefixes include: spring.datasource for SQL databases (e.g., Postgres, MySQL), spring.redis for Redis, spring.mongodb for MongoDB, and spring.rabbitmq for RabbitMQ, for example.

As mentioned above, embodiments of the present disclosure map identified dependencies from the source code and configuration files to corresponding cloud resources at 508. This process may include resource mapping and dependency detection. Resource mapping may include generating a comprehensive list of resources (e.g., AWS S3, GCP Cloud Storage, Azure Blob Storage) and developing a mapping of code patterns and configuration settings to the resources. Dependency detection may include detection and categorization of dependencies (e.g., databases, storage, compute, etc.).

Once the application source code call dependencies on cloud resources have been determined for the various categories, some embodiments may de-duplicate program calls extracted from the model to produce the unique application source code dependencies as well as the unique way each of the cloud resources is used by the applications.

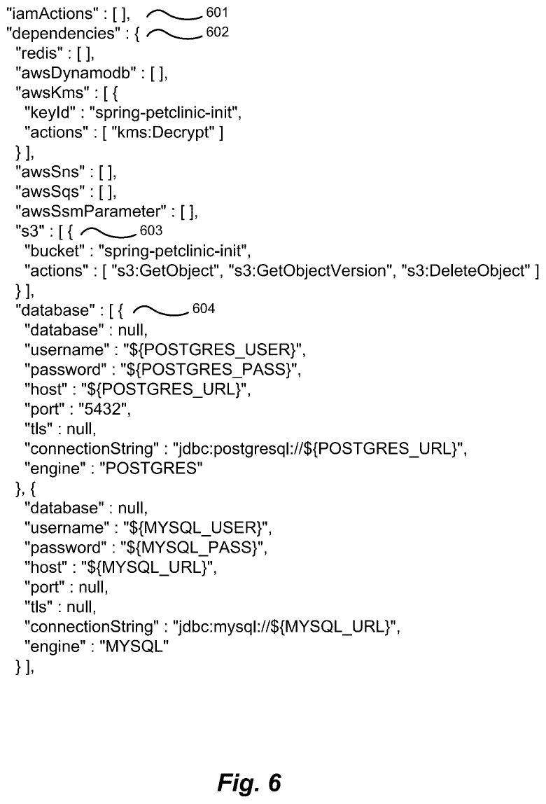

Once analyzer determines the source code dependencies, manifest generator 324 generates a dependency specification at 509 comprising dependencies between application source code calls and the target cloud environment resources. A portion of an example dependency specification (aka, manifest) is shown in FIG. 6. The manifest includes an identification of the source code feature (here, an identity and access management (IAM) resource 601) and a list of resource dependencies 602, including an S3 resource 603 and related parameters and a database 604 and related parameters, for example.

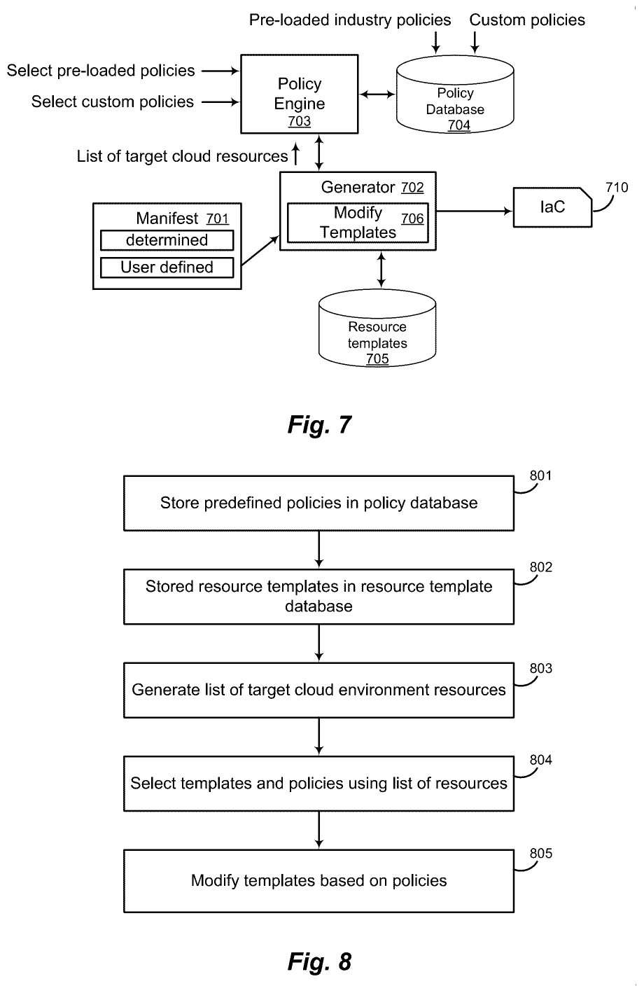

FIG. 7 illustrates integration of policy data into autogenerated IaC files according to an embodiment. This example illustrates how a manifest 701 may be combined with policy information to produce IaC files 710 comprising customized policy configurations. As mentioned above, manifest 701 includes dependency information automatically determined by the analyzer. In some embodiments, the dependency information may be presented to a user, and a user may further modify or customize the manifest with user defined dependencies, for example. As illustrated in this example, a policy engine 703 may retrieve policy data from a policy database 704 based on a list of target cloud resources determined from manifest 701 and policy selections received from a user or enterprise. Generator 702 may retrieve resource templates for the target cloud resources from a resource template data store 705. Generator 702 may then modify the resource templates at 706 using the selected policy data to create IaC files 710 customized around the selected policies. Resource templates may comprise template configuration data to configure the cloud resources to conform with particular policies, for example, which may be customized as described below.

More specifically, policy database 704 may be pre-loaded with various policies. For example, pre-loaded policies may include industry best practice and architecture design policies (e.g., architecture specifications for “well architected” frameworks), security policies, compliance policies, and user defined custom policies (e.g., enterprise defined policies particular to an organization). A variety of such policies may be pre-loaded into policy database 704, for example. Policy engine 703 may receive inputs to select particular policies to be integrated into a cloud environment deployment. For example, policy engine 704 may receive inputs selecting particular pre-loaded policies and/or particular custom policies from one or more users. Policy engine 703 may further receive a list of cloud resources derived from manifest 701. Accordingly, example inputs used to select a mix of policies from the corpus of stored policies may include (i) the target cloud resources (stack), such as AWS EKS, AWS ECS, AWS Lambda, Azure AKS, Google Cloud GRE, etc., (ii) a selection of security and compliance policies from pre-loaded policies, and (iii) a selection of user/enterprise defined custom policies (uploaded or defined in the automated environment).

As mentioned above, generator 702 may produce a list of cloud resources from manifest 701. The list of cloud resources may be used to retrieve resource templates from resource template data store 705. Resource templates may comprise template scripts for setting up/configuring a particular cloud resource. Features and advantages of the present disclosure include retrieving resource templates based on the list of resources generated from the manifest and modifying/customizing the resource templates using policy data retrieved based on user input selections and the specific resources used in the deployment. Accordingly, customized resource templates are used to create IaC files so that the IaC files provision the resources to implement the selected pre-defined policies.

The following example illustrates resource template modification based on a selected policy. An attribute of interest in a resource template for an AWS S3 storage bucket may be impacted by a selected predefined security policy. The attribute of interest may be “sse_algorithm” in “aws_s3_bucket_server_side_encryption_configuration,” for example. The following illustrates a portion of the resource template for an AWS S3 storage bucket, where server side encryption is set by default, but may be changed.

```
# Create a server-side encryption configuration for the bucket
resource “aws_s3_bucket_server_side_encryption_configuration” “this” {
  # create this resource only if var.sse_algorithm is not empty
  count = var.sse_algorithm != “” ? 1 : 0
  bucket = aws_s3_bucket.this.id
  rule {
      apply_server_side_encryption_by_default {
        kms_master_key_id = var.sse_algorithm == “aws:kms” ?
aws_kms_key.custom_s3_kms_key[0].key_id : null
        sse_algorithm = var.sse_algorithm
      }
    }
}
```

The following selected predefined policy is used to enforce s3 encryption in the above policy file:

```
{
  ″rule_id″: ″APPCD_AWS_S3_001″,
  ″name″: ″Enable encryption″,
  ″version″: ″0.0.1″,
  ″resource_type″:″aws_s3″,
  ″provider″:″aws″,
  ″description″: ″Ensure that S3 Buckets have server side encryption at rest enabled with
KMS key to protect sensitive data.″,
  ″benchmarks″: [
    ″CIS″,
    ″AWS Security″,
    ″NIST″,
    ″HIPAA″,
    ″ISO″,
    ″PCI″,
    ″SOC2″,
    ″GDPR″
  ],
  ″category″: ″Data Protection″,
  ″severity″: ″HIGH″,
  ″rules″: [
    {
      ″logical_operator″: ″AND″,
      ″conditions″: [
        {
          ″attribute″: {
            ″name″: ″sse_algorithm″,
            ″default″: ″aws:kms″,
            ″data_type″: ″string″
          },
          ″operator″: ″NOTEMPTY″,
          ″value″: ″″
        },
        {
          ″attribute″: {
            ″name″: ″sse_algorithm″,
            ″default″: ″aws:kms″,
            ″data_type″: ″string″
          },
          ″operator″: ″EQUALS″,
          ″value″: ″aws:kms″
        }
      ],
      ″remediation″: {
        ″description″: ″‘sse Algorithm‘ value should not be empty and ‘Sse Algorithm‘
should be ‘aws:kms‘ for data protection.″
      }
    }
  ]
```

The original resource template retrieved from data store 705 above is modified based on the above policy. Due to the policy application, the terraform variable sse_algorithm is updated with aws:kms after the policy is applied. The modified resource template comprises the following:

```
  “sse_algorithm”: [
      {
        “default”: “aws:kms”,
        “description”: “The server-side encryption algorithm to use. Valid values are AES256 and
aws:kms. If you specify aws:kms, a new KMS key will be provisioned and used. If empty, no
encryption is performed.”,
        “type”: “string”,
        “nullable”: true
      }
    ],
```

The initial resource template setting used aws:kms as default, but the user is able to override it. The modified resource template has the aws:kms value set, which the user can't change thereafter, for example. Similarly, the set of security and other pre-loaded predefined policies (e.g., best practices design, compliance, etc.) may thus be chosen and set by an enterprise security team (e.g., DevSecOps team) and enforced by the present automated application deployment system when the developers generate IaC files for deploying and testing their applications, for example.

FIG. 8 illustrates an example of the method of integrating policy data into autogenerated IaC files according to another embodiment. At 801, a plurality of predefined policies are stored in a policy database. At 802, a plurality of resource templates are stored in a resource template database. At 803, a list of cloud resources is generated from the dependency specification. At 804, resource templates and polices are selected. For example, a first subset of resource templates may be selected from the resource template database based on the list of cloud resources. Similarly, a first subset of predefined policies may be selected from the policy database based on the list of cloud resources and selection criteria (e.g., from the enterprise or user). At 805, one or more of the first subset of resource templates is modified based on the first subset of predefined policies. Accordingly, infrastructure-as-code files, when executed, configure the cloud resources based on the modified one or more first subset of resource templates.

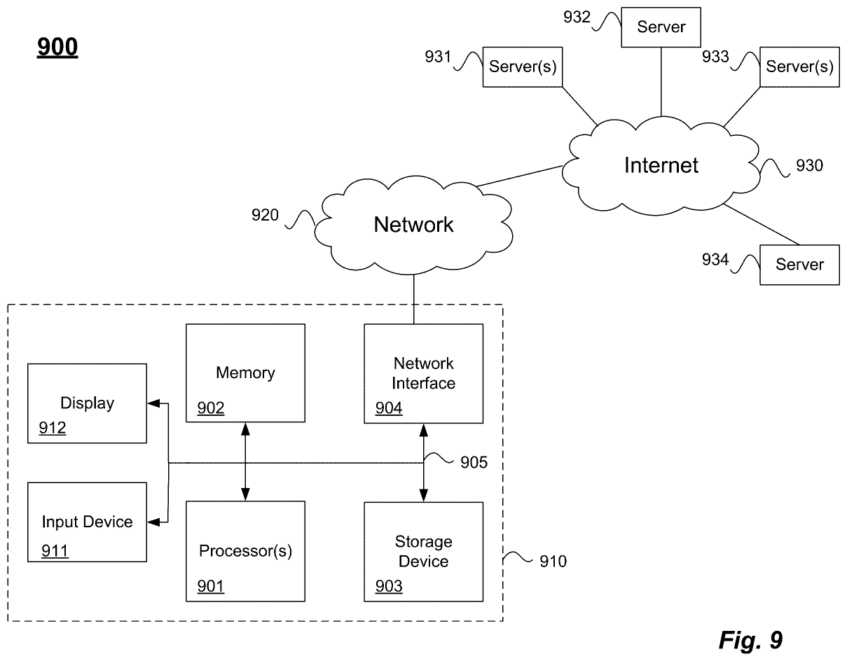

FIG. 9 illustrates a well-known computing hardware system 900 that may be configured according to the above disclosure. The following hardware description is merely one example. It is to be understood that a variety of computer hardware topologies and virtualization topologies running on top of the computer hardware may be used to implement the above-described techniques. An example computer system 910 is illustrated in FIG. 9. Computer system 910 includes a bus 905 or other communication mechanism for communicating information, and one or more processor(s) 901 coupled with bus 905 for processing information. Computer system 910 also includes memory 902 coupled to bus 905 for storing information and instructions to be executed by processor 901, including information and instructions for performing some of the techniques described above, for example. Memory 902 may also be used for storing programs executed by processor(s) 901. Possible implementations of memory 902 may be, but are not limited to, random access memory (RAM), read only memory (ROM), or both. A storage device 903 is also provided for storing information and instructions. Common forms of storage devices include, for example, a hard drive, a magnetic disk, an optical disk, a CD-ROM, a DVD, solid state disk, a flash or other non-volatile memory, a USB memory card, or any other electronic storage medium from which a computer can read. Storage device 903 may include source code, binary code, or software files for performing the techniques above, for example. Storage device 903 and memory 902 are both examples of non-transitory computer readable storage mediums (aka, storage media).

In some systems configured for direct user input and/or output, computer system 910 may be coupled via bus 905 to a display 912 for displaying information to a computer user. An input device 911 such as a keyboard, touchscreen, and/or mouse is coupled to bus 905 for communicating information and command selections from the user to processor 901. The combination of these components allows the user to communicate with the system. In some systems, bus 905 represents multiple specialized buses for coupling various components of the computer together, for example.

Computer system 910 also includes a network interface 904 coupled with bus 905. Network interface 904 may provide two-way data communication between computer system 910 and a local network 920. Network 920 may represent one or multiple networking technologies, such as Ethernet, local wireless networks (e.g., WiFi), or cellular networks, for example. The network interface 904 may be a wireless or wired connection, for example. Computer system 910 can send and receive information through the network interface 904 across a wired or wireless local area network, an Intranet, or a cellular network to the Internet 930, for example. In some embodiments, a user interface operating on computer system 910, for example, may allow a user access data and features on software that may reside on multiple different hardware servers on-prem 931 or across the network 930 (e.g., an Extranet or the Internet) on servers 932-934. One or more of servers 932-934 may also reside in a data center and be used to implement one or more cloud computing environments, for example. In some embodiments, an automated application deployment system may access application source code and configurations files on one or more servers and generate IaC files on the same or different server(s), which may be executed to produce one or more cloud computing environments on servers in one or more data centers, for example.

### Further Examples

Each of the following non-limiting features in the following examples may stand on its own or may be combined in various permutations or combinations with one or more of the other features in the examples below. In various embodiments, the present disclosure may be implemented as a system, method, or computer readable medium.

Embodiments of the present disclosure may include systems, methods, or computer readable media. In one embodiment, the present disclosure includes computer system comprising: at least one processor and at least one non-transitory computer readable medium (e.g., memory) storing computer executable instructions that, when executed by the at least one processor, cause the computer system to perform a method as described herein and in the following examples. In another embodiment, the present disclosure includes a non-transitory computer-readable medium storing computer-executable instructions that, when executed by at least one processor, perform a method as described herein and in the following examples.

In one embodiment, a method of automatically deploying an application comprising: receiving application source code and configuration information for the application; determining application source code dependencies on a plurality of cloud resources of one or more cloud environments; and generating infrastructure-as-code files based on the determined application source code dependencies to automatically deploy executable application code corresponding to the application source code on the one or more cloud environments.

In one embodiment, the present disclosure includes a method comprising: receiving, on at least one computer system, application source code and configuration information; generating, by the at least one computer system, a first model from the application source code, the first model describing dependencies between the application source code and a plurality of cloud resources on one or more cloud environments; searching, by the at least one computer system, the first model for a plurality of predefined cloud resource calls for accessing the plurality of cloud resources; extracting, by the at least one computer system, a plurality of application source code calls from the first model corresponding to the plurality of cloud resource calls; determining, by the at least one computer system, application source code dependencies on the plurality of cloud resources based on the extracted plurality of application source code calls; and generating, by the at least one computer system, infrastructure-as-code files based on the determined application source code dependencies to deploy executable application code corresponding to the application source code on the target cloud environment.

In one embodiment, the method further comprises determining parameters associated with each of the plurality of application source code calls from the first model.

In one embodiment, the method further comprises extracting parameter values for each determined parameter from the first model.

In one embodiment, the method further comprises generating a dependency specification comprising dependencies between application source code calls and the plurality of cloud resources.

In one embodiment, a first portion of components of the application source code are deployed on a first cloud environment and a second portion of components of the application source code are deployed on a second cloud environment.

In one embodiment, the method further comprises: receiving one or more custom code libraries external to the application source code; and expanding the first model to incorporate the one or more custom code libraries.

In one embodiment, searching the first model for a plurality of predefined cloud resource calls comprises: accessing the model by a plurality of processes each configured to search the model for different categories of cloud resource calls; and for each category of the cloud resource calls, determine unique application source code dependencies on corresponding cloud resources.

In one embodiment, the method further comprises de-duplicating the plurality of program calls extracted from the first model to produce unique application source code dependencies.

In one embodiment, the configuration information comprises configuration information specifying particular cloud resources the application source code relies on and configurations for the particular cloud resources.

In one embodiment, the method further comprises receiving an indication of at least one target cloud environment of a plurality of cloud environments to deploy the application source code.

In one embodiment, the method further comprises determining, from one or more of the application source code or the configuration information, at least one target cloud environment of a plurality of cloud environments to deploy the application source code.

In one embodiment, the first model represents at least a structure, a control flow, and a data flow of the application source code and corresponding cloud resources.

In one embodiment, the first model is a code property graph or an abstract syntax tree.

In one embodiment, the method further comprises provisioning the one or more cloud environments using the infrastructure-as-code files.

In one embodiment, said provisioning the one or more cloud environments generates at least one new cloud environment and deploys at least a portion of the executable application code on the at least one new cloud environment.

In one embodiment, said provisioning the one or more cloud environments modifies at least one existing cloud environment and deploys at least a portion of the executable application code on the at least one existing cloud environment.

In one embodiment, the method further comprises: storing a plurality of predefined policies in a policy database; storing a plurality of resource templates in a resource template database; generating, from the dependency specification, a list of cloud resources; selecting, based on the list of cloud resources, a first subset of resource templates from the resource template database; selecting, based on the list of cloud resources, a first subset of predefined policies from the policy database; and modifying one or more of the first subset of resource templates based on the first subset of predefined policies, wherein the infrastructure-as-code files, when executed, configure the cloud resources based on the modified one or more first subset of resource templates.

In one embodiment, the resource templates comprise template configuration data to configure the cloud resources to conform with particular policies.

In one embodiment, the present disclosure includes a computer implemented method comprising: receiving application source code and configuration information; generating a first model from the application source code, the first model describing dependencies between the application source code and a plurality of cloud resources on one or more cloud environments, wherein the first model represents at least a structure, a control flow, and a data flow of the application source code and corresponding cloud resources; searching the first model for a plurality of predefined cloud resource calls for accessing the plurality of cloud resources, wherein searching the first model for a plurality of predefined cloud resource calls comprises: accessing the model by a plurality of processes each configured to search the model for different categories of cloud resource calls; and for each category of the cloud resource calls, determine unique application source code dependencies on corresponding cloud resources; extracting a plurality of application source code calls from the first model corresponding to the plurality of cloud resource calls; determining application source code dependencies on the plurality of cloud resources based on the extracted plurality of application source code calls; generating, based on said determining, a dependency specification comprising dependencies between application source code calls and the plurality of cloud resources; generating, from the dependency specification, a list of cloud resources; selecting, based on the list of cloud resources, a first subset of resource templates from the resource template database, the resource template database storing a plurality of resource templates; selecting, based on the list of cloud resources, a first subset of predefined policies from the policy database, the policy database storing a plurality of predefined policies; modifying one or more of the first subset of resource templates based on the first subset of predefined policies; and generating infrastructure-as-code files based on the determined application source code dependencies to deploy executable application code corresponding to the application source code on the one or more cloud environments, wherein the infrastructure-as-code files, when executed, configure the cloud resources based on the modified one or more first subset of resource templates.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A method comprising:
receiving, on at least one computer system, application source code and configuration information;
generating, by the at least one computer system, a first model from the application source code, the first model describing dependencies between the application source code and a plurality of cloud resources on one or more cloud environments;
searching, by the at least one computer system, the first model for a plurality of predefined cloud resource calls for accessing the plurality of cloud resources;
extracting, by the at least one computer system, a plurality of application source code calls from the first model corresponding to the plurality of cloud resource calls;
determining, by the at least one computer system, application source code dependencies on the plurality of cloud resources based on the extracted plurality of application source code calls; and
generating, by the at least one computer system, infrastructure-as-code files based on the determined application source code dependencies to deploy executable application code corresponding to the application source code on the target cloud environment.

2. The method of claim 1, further comprising determining parameters associated with each of the plurality of application source code calls from the first model.

3. The method of claim 2, further comprising extracting parameter values for each determined parameter from the first model.

4. The method of claim 1, further comprising generating a dependency specification comprising dependencies between application source code calls and the plurality of cloud resources.

5. The method of claim 1, wherein a first portion of components of the application source code are deployed on a first cloud environment and a second portion of components of the application source code are deployed on a second cloud environment.

6. The method of claim 1, further comprising:
receiving one or more custom code libraries external to the application source code; and
expanding the first model to incorporate the one or more custom code libraries.

7. The method of claim 1, wherein searching the first model for a plurality of predefined cloud resource calls comprises:
accessing the model by a plurality of processes each configured to search the model for different categories of cloud resource calls; and
for each category of the cloud resource calls, determine unique application source code dependencies on corresponding cloud resources.

8. The method of claim 7, further comprising de-duplicating the plurality of program calls extracted from the first model to produce unique application source code dependencies.

9. The method of claim 1, wherein the configuration information comprises configuration information specifying particular cloud resources the application source code relies on and configurations for the particular cloud resources.

10. The method of claim 1, further comprising receiving an indication of at least one target cloud environment of a plurality of cloud environments to deploy the application source code.

11. The method of claim 1, further comprising determining, from one or more of the application source code or the configuration information, at least one target cloud environment of a plurality of cloud environments to deploy the application source code.

12. The method of claim 1, wherein the first model represents at least a structure, a control flow, and a data flow of the application source code and corresponding cloud resources.

13. The method of claim 1, wherein the first model is a code property graph or an abstract syntax tree.

14. The method of claim 1, further comprising provisioning the one or more cloud environments using the infrastructure-as-code files.

15. The method of claim 14, wherein said provisioning the one or more cloud environments generates at least one new cloud environment and deploys at least a portion of the executable application code on the at least one new cloud environment.

16. The method of claim 14, wherein said provisioning the one or more cloud environments modifies at least one existing cloud environment and deploys at least a portion of the executable application code on the at least one existing cloud environment.

17. The method of claim 1, further comprising:
storing a plurality of predefined policies in a policy database;
storing a plurality of resource templates in a resource template database;
generating, from the dependency specification, a list of cloud resources;
selecting, based on the list of cloud resources, a first subset of resource templates from the resource template database;
selecting, based on the list of cloud resources, a first subset of predefined policies from the policy database; and
modifying one or more of the first subset of resource templates based on the first subset of predefined policies,
wherein the infrastructure-as-code files, when executed, configure the cloud resources based on the modified one or more first subset of resource templates.

18. The method of claim 17, wherein the resource templates comprise template configuration data to configure the cloud resources to conform with particular policies.

19. A computer implemented method comprising:
receiving application source code and configuration information;
generating a first model from the application source code, the first model describing dependencies between the application source code and a plurality of cloud resources on one or more cloud environments, wherein the first model represents at least a structure, a control flow, and a data flow of the application source code and corresponding cloud resources;
searching the first model for a plurality of predefined cloud resource calls for accessing the plurality of cloud resources, wherein searching the first model for a plurality of predefined cloud resource calls comprises: accessing the model by a plurality of processes each configured to search the model for different categories of cloud resource calls; and for each category of the cloud resource calls, determine unique application source code dependencies on corresponding cloud resources;
extracting a plurality of application source code calls from the first model corresponding to the plurality of cloud resource calls;
determining application source code dependencies on the plurality of cloud resources based on the extracted plurality of application source code calls;
generating, based on said determining, a dependency specification comprising dependencies between application source code calls and the plurality of cloud resources;
generating, from the dependency specification, a list of cloud resources;
selecting, based on the list of cloud resources, a first subset of resource templates from the resource template database, the resource template database storing a plurality of resource templates;
selecting, based on the list of cloud resources, a first subset of predefined policies from the policy database, the policy database storing a plurality of predefined policies;
modifying one or more of the first subset of resource templates based on the first subset of predefined policies; and
generating infrastructure-as-code files based on the determined application source code dependencies to deploy executable application code corresponding to the application source code on the one or more cloud environments, wherein the infrastructure-as-code files, when executed, configure the cloud resources based on the modified one or more first subset of resource templates.

20. A computer system comprising:
at least one processor;
at least one non-transitory computer readable medium storing computer executable instructions that, when executed by the at least one processor, cause the computer system to perform a method of automatically deploying an application comprising:
receiving application source code and configuration information for the application;
determining application source code dependencies on a plurality of cloud resources of one or more cloud environments; and
generating infrastructure-as-code files based on the determined application source code dependencies to automatically deploy executable application code corresponding to the application source code on the one or more cloud environments.
